(19) United States
(12) Patent Application Publication
(10) Pub. No.: US 2012/0299416 A1
(43) Pub. Date: Nov. 29, 2012

(54) GEAR MOTOR AND GEAR GENERATOR

(76) Inventor: Koufeng CHEN, Pingtung City (TW)

(21) Appl. No.: 13/113,595

(22) Filed: May 23, 2011

(51) Int. Cl. F16H 1/28; H02K 7/116

(52) U.S. Cl. 310/83; 475/149

(57) ABSTRACT

A high-torque motor device, comprising: a shaft, an electromagnetic unit with a stator and a rotor, and a single-stage planetary gear unit set onto the rotor. The single-stage planetary gear unit is provided with a planetary gear disk firmly sleeved onto the shaft, a plurality of planetary gears pivoted onto the planetary gear disk, an internal ring gear meshed with the planetary gear, and a sun gear fixed onto the rotor and meshed with the planetary gear. The present invention allows a single shaft between the motor and planetary gear unit, thus shortening the axial length of entire device and further guaranteeing the assembly precision of parts. This structure can be applied to motor and generator.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a gear motor, and more particularly to a gear motor or gear generator with high torque.

2. Description of Related Art Including Information Disclosed Under 37 CFR 1.97 and 37 CFR 1.98.

In the application fields of electric tools or power-operated machines, the gear motors combined with planetary gear set could reduce greatly the dimension of motors, and realize high-power and high torque due to the design of high reduction ratio.

The currently available gear motors combined with planetary gear set are designed in such a manner that the gear set and internal motor are separated, and radial air-gap motors with longer shafts are widely used, making it difficult for the occasions placing special requirements for the axial space.

For example, as illustrated in U.S. Pat. No. 5,123,300, a phase adjustment mechanism combining disc motor with planetary gear set is used for phase adjustment of output and input shafts, namely, with the traditional design of declutch shaft and declutch gear, the gear motor has shortcomings with respect to the axial length or alignment precision of components. To improve the poor alignment precision, some technologies are developed in the industry, e.g.: U.S. Pat. No. 6,966,391 illustrates a design that can improve the alignment precision of front and rear shafts; however, due to different rotation speeds of the motor shaft and final output shaft, the high-precision design with a single through-going shaft cannot be realized, leading to rather complex design of the relevant shaft seal structure (e.g.: U.S. Pat. No. 7,182,709).

There is still a room for improvement of the axial dimension or alignment precision of components of the gear motor combined with planetary gear set.

### BRIEF SUMMARY OF THE INVENTION

The primary objective of the present invention is to provide a thin-profile gear motor that combines with a planetary gear set and reduces greatly the axial dimension while featuring high alignment precision of components.

Hence, the gear motor of the present invention comprises: a shaft, an electromagnetic unit and a single-stage planetary gear unit.

The electromagnetic unit is provided with a stator and a rotor pivoted onto the shaft for rotation in relation to the stator.

The single-stage planetary gear unit is provided with a planetary gear disk fixed onto and coaxially rotated with the shaft, a plurality of planetary gears pivoted rotarily onto the planetary gear disk, an internal ring gear fixed in relation to the stator of the electromagnetic unit and meshed with the planetary gear, and a sun gear fixed onto the rotor of the electromagnetic unit, coaxially rotated with the rotor, and meshed with the planetary gear.

The other purpose of the present invention is to provide a thin-profile gear motor that combines with a multi-stage planetary gear set and reduces greatly the axial dimension while featuring high alignment precision of components. The gear motor comprises: a shaft, an electromagnetic unit and a multi-stage planetary gear unit.

The electromagnetic unit is provided with a stator and a rotor pivoted onto the shaft for rotation in relation to the stator.

The multi-stage planetary gear unit is provided with a first planetary gear disk fixed onto and coaxially rotated with the shaft, a plurality of first planetary gears pivoted rotarily onto the first planetary gear disk, a first internal ring gear fixed in relation to the stator and meshed with the first planetary gear, a first sun gear meshed with the first planetary gear, a second planetary gear disk sleeved rotarily onto the shaft and also sleeved by the first sun gear, a plurality of second planetary gears pivoted rotarily onto the second planetary gear disk, a second internal ring gear fixed in relation to the stator and meshed with the second planetary gear, and a second sun gear fixed onto the rotor of the electromagnetic unit and coaxially rotated with the rotor, and also meshed with the second planetary gear.

The efficacies of the present invention lie in that, the sun gear is directly sleeved onto the rotor, such that main rotating parts can rotate on the same shaft. With the design of such a single shaft, it is possible to shorten the axial length of entire device and guarantee the concentricity of parts so as to improve the assembly precision of parts.

Based on above-specified design, the gear motor of the present invention has the following advantages:

High-Precision Design:

The sun gear 44 is directly incorporated onto the rotor 32, such that a single shaft 2 is used as the basis of rotation and alignment of various parts, and main rotating parts have the same rotating axis; hence, the concentricity of rotating parts can be more accurately controlled to realize high-precision manufacturing and operation while improving poorer manufacturing precision or the problems requiring complex shaft seal and alignment mechanism.

Excellent Structural Robustness:

With the structural design of single shaft 2, various parts could be structured more robustly, so as to ensure excellent structural robustness with the radial support of the bearing unit 5.

Compact Design:

With the compact configuration of various parts and the design of incorporating the sun gear 44 onto the rotor 32, the axial length of the entire mechanism is shortened greatly for the compactness, so the present invention can be widely applied to the products to be arranged in confined space and requiring high torsion output (e.g.: in-wheel motor).

Application to Auxiliary Drive:

Owing to the design of single shaft 2, the present invention can also be applied to auxiliary drive, e.g. HEV.

To sum up, the gear motor of the present invention allows to sleeve directly the sun gear 44 onto the rotor 32, such that the rotation and alignment of main rotating parts can be guaranteed by a single shaft 2 to ensure the assembly precision, shorten greatly the axial length and enhance the structural robustness of entire mechanism.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a partial sectional view illustrating partial section of the first preferred embodiment of the gear motor of the present invention;

FIG. 2 is a 3D exploded view illustrating the first preferred embodiment;

FIG. 3 is a partial sectional view illustrating partial section of the second preferred embodiment of the gear motor of the present invention;

FIG. 4 is a partial sectional view illustrating partial section of the third preferred embodiment of the gear motor of the present invention; and

FIG. 5 is a partial sectional view illustrating partial section of the fourth preferred embodiment of the gear motor of the present invention.

### DETAILED DESCRIPTION OF THE INVENTION

The features and the advantages of the present invention will be more readily understood upon the following detailed description of four preferred embodiments of the present invention with reference to the accompanying drawings.

Prior to detailed description of the present invention, similar parts are represented by the same reference numeral.

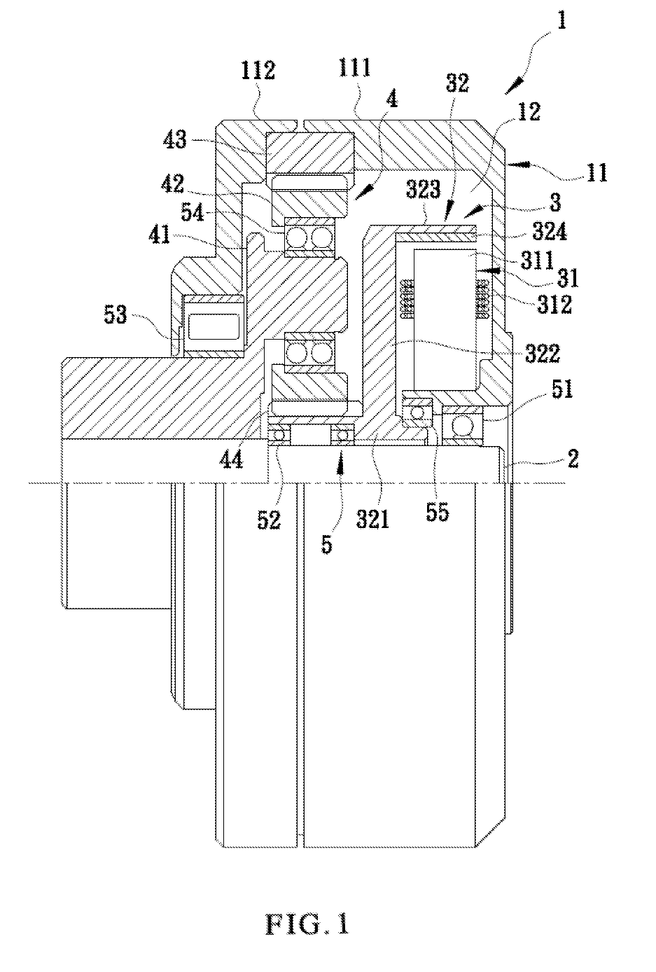

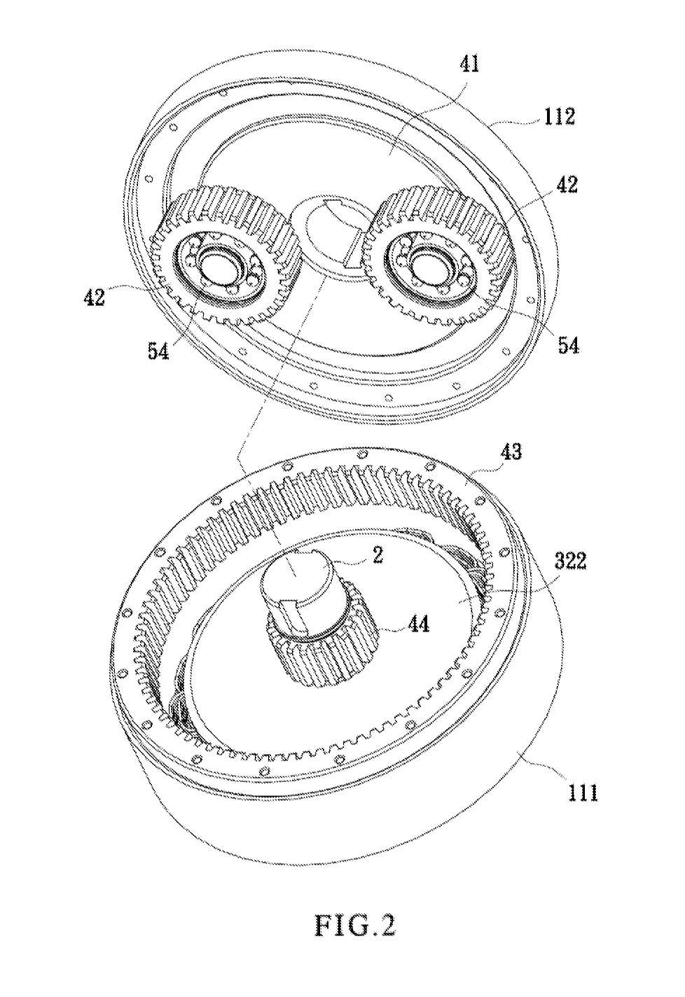

Referring to FIG. 1 in collaboration with FIG. 2, the first preferred embodiment of the gear motor of the present invention comprises: a casing body 1, a shaft 2, an electromagnetic unit 3, a single-stage planetary gear unit 4 and a bearing unit 5. It is worthy to note that, as the structure is symmetrical, only a half of structure is illustrated in FIG. 1 (and subsequent sectional views).

The casing body 1 is provided with a casing 11 and a holding space 12 defined by the casing 11. The casing 11 is provided with a first casing portion 111 and a second casing portion 112 connected oppositely to define essentially the holding space 12. In addition, the first and second casing portions 111, 112 are also configured with a fixed structure, e.g.: a hanger with screwed hole, used to fasten the first and second casing portions 111, 112 onto the available carrier.

The shaft 2 is set into the holding space 12 and extended out of the first and second casing portions 111, 112 of the casing 11. The first and second casing portions 111, 112 of the casing 11 can rotate in relation to the shaft 2. It is worthy to note that, the following wordings of “radially” and “axially” are based on the shaft 2.

The electromagnetic unit 3 is provided with a stator 31 radially fixed onto the first casing portion 111 of the casing 11 and located in the holding space 12, and a rotor 32 located in the holding space 12, concentrically pivoted onto the shaft 2 and rotated in relation to the stator 31. In this preferred embodiment, the stator 31 is provided with an iron core 311 radially fixed onto the first casing portion 111, and a coil assembly 312 radially wound onto the iron core 311. The rotor 32 is provided with a pivoting portion 321 concentrically pivoted onto the shaft 2, an extension 322 radially extended from the pivoting portion 321, an assembly portion 323 axially extended from the end of the extension 322 and moved around the end of the iron core 311, and a magnet 324 set laterally onto the assembly portion 323 facing the iron core 311 and keeping a spacing with the end of the iron core 311, so as to form electromagnetic reaction with the iron core 311 and coil assembly 312. In this preferred embodiment, the coil assembly 312 is wound onto the iron core 311, but not limited to this configuration, and the coil assembly 312 can also be routed to flexible printed circuit board.

The single-stage planetary gear unit 4 is provided with a planetary gear disk 41 located in the holding space 12, sleeved firmly onto the shaft 2 and coaxially rotated with the shaft 2, a plurality of planetary gears 42 (only a single one shown in FIG. 1) rotarily pivoted onto the planetary gear disk 41, an internal ring gear 43 fixed onto the first/second casing portion 111, 112, located in the holding space 12 and meshed with the planetary gear 42, and a sun gear 44 coaxially sleeved onto the pivoting portion 321 of the rotor 32, coaxially rotated with the pivoting portion 321, and meshed with the planetary gear 42.

The bearing unit 5 is provided with a first bearing 51 sleeved onto the shaft 2 and located between the shaft 2 and the first casing portion 111 of the casing 11, a second bearing 52 sleeved onto the shaft 2 and located between the shaft 2 and the pivoting portion 321 of the rotor 32, a third bearing 53 sleeved onto the planetary gear disk 41 and located between the planetary gear disk 41 and the second casing portion 112 of the casing 11, a plurality of fourth bearings 54 (only a single one shown in FIG. 1) set onto the planetary gear disk 41 correspondingly to the planetary gear 42, so as to support separately the planetary gear 42, and a fifth bearing 55 pivoted onto the pivoting portion 321 of the rotor 32 and located between the pivoting portion 321 and the first casing portion 111 of the casing 11. In this preferred embodiment, the first-fifth bearings 51 -55 are implemented in the form of ball bearing.

The rotor 32, planetary gear disk 41 and shaft 2 rotate along the same rotating axis of the shaft 2. After the coil assembly 312 of the stator 31 of the electromagnetic unit 3 is energized, a magnetic field will be generated together with the iron core 311, such that the magnetic repulsion could drive the magnet 324 on the assembly portion 323 to couple with the extension 322, pivoting portion 321, and also enable rotation of the sun gear 44 on the pivoting portion 321 along the rotating axis of the shaft 2. In such a case, the planetary gear 42 meshed with the sun gear 44 is driven to rotate along its own axis. As the planetary gear 42 is meshed with the internal ring gear 43 kept in relative static status, the planetary gear disk 41 starts to rotate along the rotating axis of the shaft 2 (namely, the planetary gear 42 could rotate along its own axis and also along the axis of the shaft 2, so as to drive the planetary gear disk 41). Meanwhile, the shaft 2 connected coaxially with the planetary gear disk 41 is driven by the planetary gear disk 41 to rotate along its own axis. As such, an intended reduction ratio could be obtained from the preset gear ratio of the planetary gear 42, sun gear 44 and internal ring gear 43, thus allowing the shaft 2 to generate high torsion output.

According to aforementioned description, the gear motor is used as a motor, but it can also be used as a generator. That is to say, when the shaft 2 is coupled to an external rotating mechanism and rotated accordingly, the magnet 324 on the assembly portion 323 is driven to rotate by the reverse coupling mode, so as to generate an alternating magnetic field encircling the iron core 311 and coil assembly 312, and a counter electromotive force on the coil assembly 312 for electric energy output.

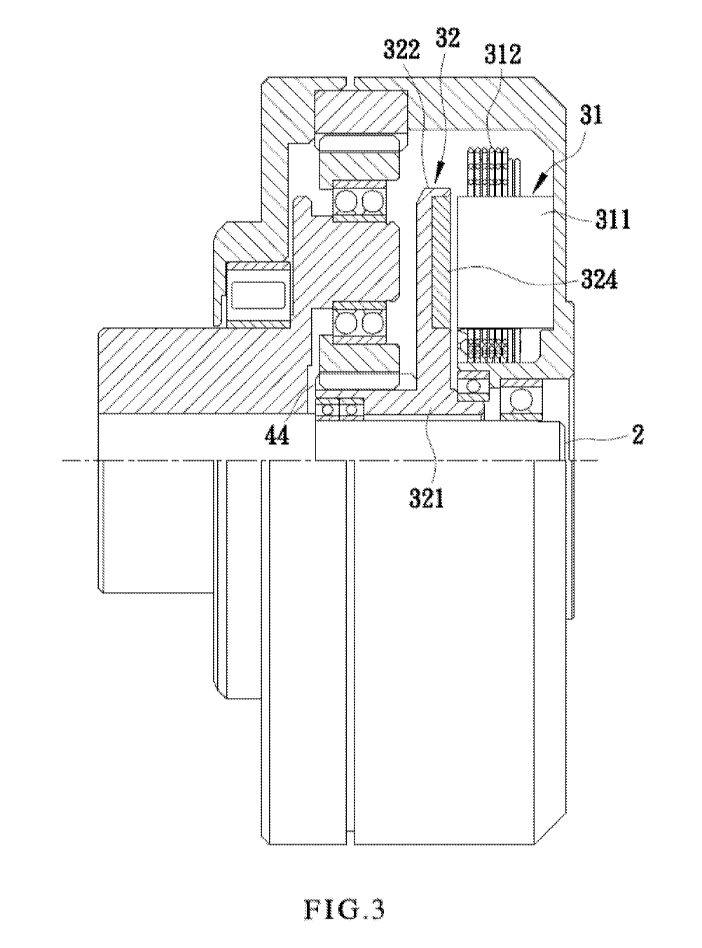

Referring to FIG. 1 in collaboration with FIG. 3, the second preferred embodiment of the gear motor of the present invention is almost the same with the first one, but the difference lies in that: the stator 31 of this preferred embodiment is provided with an iron core 311 axially set onto the casing 11 and located in the holding space 12, and a coil assembly 312 axially wound onto the iron core 311. The rotor 32 is provided with a pivoting portion 321 pivoted onto the shaft 2 for sleeving of the sun gear 44, an extension 322 extended radially from the pivoting portion 321, and a magnet 324 set laterally onto the pivoting portion 321 facing the iron core 311, so as to form electromagnetic reaction with the iron core 311 and coil assembly 312.

In this preferred embodiment, the iron core 311 and coil assembly 312 of the stator 31 are configured axially, such that the magnet 324 can be directly mounted onto the extension 322 to generate electromagnetic reaction with the iron core 311 and coil assembly 312. In such a case, the assembly portion 323 (FIG. 1) is not required for the assembly of the magnet 324, such that the structure of the rotor 32 is simplified for easier manufacturing.

In this preferred embodiment, the coil assembly 312 is wound onto the iron core 311, but not limited to this configuration, and the coil assembly 312 can also be routed to flexible printed circuit board. (disclosed in U.S. Pat. No. 4,455,516).

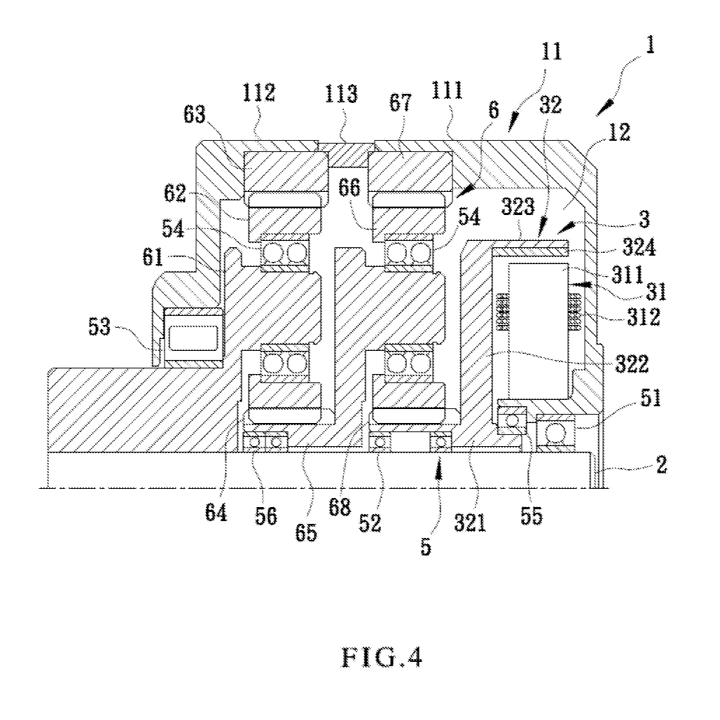

Referring to FIG. 1 in collaboration with FIG. 4, the third preferred embodiment of the gear motor of the present invention is almost the same with the first one, but the difference lies in that: the multi-stage planetary gear unit 6 of this preferred embodiment is provided with a first planetary gear disk 61 located in the holding space 12, sleeved firmly onto the shaft 2 and coaxially rotated with the shaft 2, a plurality of first planetary gears 62 (only a single one shown in FIG. 4) rotarily pivoted onto the first planetary gear disk 61, a first internal ring gear 63 set onto the second casing portion 112 of the casing 11, located in the holding space 12 and meshed with the first planetary gear 62, a first sun gear 64 located in the holding space 12 and meshed with the first planetary gear 62, a second planetary gear disk 65 located in the holding space 12, and rotarily sleeved onto the shaft 2 for sleeving of the first sun gear 64, a plurality of second planetary gears 66 rotarily pivoted onto the second planetary gear disk 65, a second internal ring gear 67 set onto the first casing portion 111 of the casing 11, located in the holding space 12 and meshed with the second planetary gear 66, and a second sun gear 68 set onto the pivoting portion 321 of the rotor 32, coaxially rotated with the rotor 32 and meshed with the second planetary gear 66.

Furthermore, the bearing unit 5 of this preferred embodiment is provided with a sixth bearing 56 sleeved onto the shaft 2 and located between the shaft 2 and second planetary gear disk 65, such that the second planetary gear disk 65 can be rotarily arranged on the shaft 2. In this preferred embodiment, the sixth bearing 56 is also implemented in the form of a ball bearing.

In addition, the casing 11 of the casing body 1 is constructed with a first casing portion 111, a second casing portion 112 and a joint 113 linking the first and second casing portions 111, 112. The first and second casing portions 111, 112 are separately used for arrangement of the first and second internal ring gears 63, 67. The first bearing 51 of the bearing unit 5 is located between the shaft 2 and the first casing portion 111, and the third bearing 53 located between the first planetary gear disk 61 and second casing portion 112.

With this construction, after the coil assembly 312 of the stator 31 is energized, the magnetic repulsion could drive the rotor 32, which then couples with the second sun gear 68, second planetary gear 66 and second planetary gear disk 65 for rotation. The second planetary gear disk 65 furthermore couples with the first sun gear 64, first planetary gear 62, first planetary gear disk 61 and the shaft 2 set on the first planetary gear disk 61 for rotation of the shaft 2. If this preferred embodiment is implemented as a generator, it could be operated reversely, and those skilled in the art could deduce the implementation mode based on the coupling relation of parts.

By integrating the multi-stage planetary gear system, this preferred embodiment allows to increase the torsion output of the shaft 2 by more flexible design of the reduction ratio. Certainly, the planetary gear system could be configured into three, four or more stages where applicable, so more multiple-stage preferred embodiments could be developed by those skilled in the art.

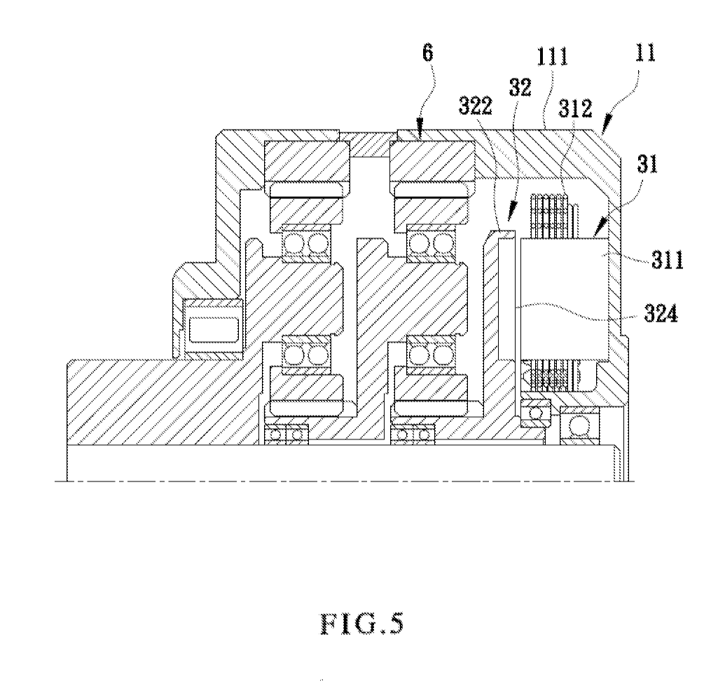

Referring to FIG. 4 in collaboration with FIG. 5, the fourth preferred embodiment of the gear motor of the present invention is almost the same with the second one, but the difference lies in that: the multi-stage planetary gear unit 6 is configured in collaboration with the stator 31, which is provided with an iron core 311 set on the first casing portion 111 of the casing 11, and a coil assembly 312 axially wound onto the iron core 311; so the magnet 324 of the rotor 32 can be directly arranged on the extension 322 to further simplify the structure of the rotor 32 as in the second preferred embodiment.

I claim:

1. A gear motor, comprising: a shaft, a single-stage planetary gear unit and an electromagnetic unit; said electromagnetic unit is provided with a stator and a rotor pivoted onto said shaft for rotation in relation to said stator; said single-stage planetary gear unit is provided with a planetary gear disk fixed onto and coaxially rotated with said shaft, a plurality of planetary gears pivoted rotarily onto said planetary gear disk, an internal ring gear fixed in relation to said stator and meshed with said planetary gears, and a sun gear fixed onto said rotor, coaxially rotated with the rotor, and meshed with said planetary gears; it is characterized by that: the stator and rotor of said electromagnetic unit are pivoted onto said shaft.

2. The structure defined in claim 1, wherein the stator of said electromagnetic unit is provided with a coil assembly and an iron core set for winding of said coil assembly; the rotor of said electromagnetic unit is provided with a magnet assembly for generating electromagnetic reaction with said coil assembly.

3. The structure defined in claim 2, wherein said magnet assembly is radially aligned with said coil assembly.

4. The structure defined in claim 2, wherein said magnet assembly is axially aligned with said coil assembly.

5. A gear motor, comprising: a shaft, a multi-stage planetary gear unit and an electromagnetic unit; said electromagnetic unit is provided with a stator, and a rotor rotating in relation to said stator; each stage of said multi-stage planetary gear unit is provided with a planetary gear disk rotating by taking said shaft as axis, a plurality of planetary gears of said stage rotarily pivoted onto said planetary gear disk, at least one internal ring gear fixed in relation to said stator and meshed with said planetary gears, and a sun gear of said stage pivoted onto said shaft and meshed with the planetary gears of the same stage; said sun gear is set onto said planetary gear disk of next stage; it is characterized by that: the stator and rotor of said electromagnetic unit are pivoted onto said shaft, the first planetary gear disk of said multi-stage planetary gear unit is fixed onto said shaft, and the final stage sun gear of said multi-stage planetary gear unit is fixed onto and coaxially rotated with said rotor.

6. The structure defined in claim 5, wherein the stator of said electromagnetic unit is provided with a coil assembly and an iron core set for winding of said coil assembly; the rotor of said electromagnetic unit is provided with a magnet assembly for generating electromagnetic reaction with said coil assembly.

7. The structure defined in claim 6, wherein said magnet assembly is radially aligned with said coil assembly.

8. The structure defined in claim 6, wherein said magnet assembly is axially aligned with said coil assembly.
